(19) United States
(12) Patent Application Publication
(10) Pub. No.: US 2025/0234820 A1
(43) Pub. Date: Jul. 24, 2025

(54) MOLDED IRRIGATION PIVOT WHEEL HAVING A REVERSIBLE OFFSET WHEEL HUB ASSEMBLY

(71) Applicant: Robert Dale Krause, Fruitland, ID (US)

(72) Inventor: Robert Dale Krause, Fruitland, ID (US)

(21) Appl. No.: 19/034,533

(22) Filed: Jan. 22, 2025

Related U.S. Application Data
(60) Provisional application No. 63/623,791, filed on Jan. 22, 2024.

(51) Int. Cl. A01G 25/09; B60B 3/00; B60B 3/02

(52) U.S. Cl. CPC A01G 25/092; B60B 3/004; B60B 3/02

(57) ABSTRACT

A molded irrigation pivot wheel rotationally molded from a linear low-density polyethylene resin that has a reversible offset wheel hub assembly mounted in a central transverse core of the wheel for attaching to a selected drive disc of an attached pivot line gearbox. The invention is particularly useful having a reversible offset wheel hub assembly that can be mounted to one or the other of two gearboxes where each gearbox having a different linear offset distance to its drive disc.

### CROSS-REFERENCE TO RELATED APPLICATIONS

Not Applicable

### STATEMENT REGARDING FEDERALLY SPONSORED RESEARCH OR DEVELOPMENT

### Not Applicable

### REFERENCE TO A MICROFICHE APPENDIX

Not Applicable

### BACKGROUND OF THE INVENTION

### 1. Field of the Invention

The present invention relates to a novel molded irrigation pivot wheel 4 for supporting and moving one or more irrigation towers of an operative agricultural irrigation pivot line. The wheel is preferably rotationally molded from a linear low-density polyethylene (LLDPE) resin, said wheel having an axial wheel central transverse bore 6 and having a reversible offset wheel hub assembly 8 for close operable and coaxial mounting in said central transverse bore and attaching to a selected drive disc 200, 202 of an attached pivot line gearbox 204, 206 of one of said irrigation towers and said gearbox having operatively attached one of said drive discs, and each said disc having an eight by eight (8×8) array of eight mounting studs 208, said selected drive disc is powered by said gearbox and the rotation of said attached drive disc powers the rotating of said attached wheel to move said irrigation tower of an operative agricultural irrigation system (commonly one of said drive discs is observed to be linearly offset from its attached gearbox by approximately four inches and the other drive disc is linearly offset from its attached gearbox by approximately seven (7) inches). See FIGS. 15 and 16 and their respective reference letters A and B that illustrate similar sized drive discs and two different linear offset distances.

The claimed irrigation pivot wheel is a hollow rotationally molded wheel for use in conjunction with an agricultural irrigation system such as a pivot line or wheel line and the support and movement of irrigation towers.

### 2. Description of Related Art

### Brief Summary of the Invention

A principal objective of this invention is to provide a novel and improved pivot wheel 4 having an axial wheel central transverse bore 6 and having a reversible offset wheel hub assembly 8 and preferably having a plurality of transverse through wheel bores 10 radially spaced about said wheel central transverse bore to receive and retain a plurality of through wheel hub assembly securement bolts 12, said offset wheel hub assembly may be used to selectively and operationally attach a drive disc 200, 202 of one or another of two or more preexisting agricultural irrigation drive-line gearboxes each having one of two or more different external offset linear length drive shaft configurations to one side or the other of said pivot wheel.

The wheel hub assembly 8 has a top-hat shaped portion 14 having a planar top-side inner ring 15 and said top-hat portion sized to closely fit in and through said central transverse bore 6 with said inner ring in close planar alignment with the opposite wheel side at the other end of said central transverse bore and said top-hat portion retained in said central transverse bore from and through from one wheel side to the other wheel side and said top-hat shaped portion attached by a plurality of retention bolts 16 to a plurality of embedded bolt retention anchors 18, said anchors were previously embedded in each opposite spaced wheel side in a radially spaced, aligned, and distributed manner about the rotational center axis of said wheel in both sides of the wheel during its molding process, said anchors receive and reversably retain said retention bolts through a plurality of hub assembly mounting bores 20 in a brim-ring portion 22 of said top-hat portion and said mounting bores positioned in a radially spaced, cooperatively aligned, and distributed manner about the rotational center axis of said top-hat portion to align with said anchors, preferably said brim-ring portion having a plurality of transverse through wheel bores 24 radially spaced and distributed about said wheel central transverse bore to receive and retain a plurality of hub assembly securement bolts 12.

Preferably said top-hat portion is further secured in said central transverse bore on one side of said wheel to a spaced circular planar doubler plate 28 on the opposite side of said wheel by means of said securement bolts secured through a plurality of doubler plate securement bores 30, to securely attach said doubler plate 28 to portions of each side of the wheel that closely surround said hub assembly is secured in and to portions of both lateral sides of the wheel via said mounting bores 20 of said brim-ring portion in cooperation with a plurality of retention bolts that closely secure the hub assembly in said central transverse bore to the adjacent wheel outer side portion overlapped by said brim-ring portion by a plurality of radially spaced and distributed retention bolts 16.

With a selectively and appropriately sized cylindrical wheel hub wall 25, a planar top-side inner ring 15 extends through said central transverse bore to be in close planar proximity to the plane of the outer surface of said wheel that radially and immediately surrounds said central transverse bore, said inner ring having a transverse top-hat portion transverse center bore 23, thereafter said doubler plate is closely secured to said wheel via said mounting bores of said doubler plate in cooperation with a plurality of retention bolts that closely secure said hub assembly in said central transverse bore to the adjacent wheel outer side portion overlapped by said doubler plate by said plurality of radially spaced retention bolts 16. Thereafter said doubler plate is in close adjacent and coaxial alignment with said top-side inner ring.

Thereafter said adjacent inner ring and said doubler plate can be coaxially attached to a selected drive disc and operatively attached to said gearbox with appropriate fasteners through a plurality of coaxially aligned gearbox mounting bores and 33 of said adjacent inner ring and said doubler plate from one side of said wheel or the other side of said wheel.

Additional and various other objects and advantages attained by the invention will become more apparent as the specification is read and the accompanying figures are reviewed.

### BRIEF DESCRIPTION OF THE SEVERAL VIEWS OF THE DRAWING

FIG. 1 is a front view of a molded irrigation pivot wheel 4 showing a rotationally molded wheel having a coaxial central transverse bore 6 for receiving, mounting and retaining an offset wheel hub assembly 8 from either the front side or the back side of said wheel;

FIG. 2 is a perspective view of the irrigation pivot wheel of FIG. 1 showing said offset wheel hub assembly 8 mounted to said wheel by a plurality of radially spaced retention bolts 16 and a plurality of radially spaced securement bolts 12;

FIG. 3 is a front view of a molded irrigation pivot wheel 4 showing a rotationally molded wheel having a coaxial wheel central transverse bore 6 for receiving, mounting and retaining an offset wheel hub assembly 8 (not shown) from either the front-side or the rear-side of said wheel via a plurality of retention bolts 16 (not shown) secured to a plurality of appropriately aligned bolt retention anchors 18 that were embedded and molded into the two outer opposite side portions of the wheel radially spaced around the center bore of the wheel on each side of the wheel;

FIG. 4 is an exploded view of a wheel hub assembly 8 and a cooperating spaced circular planar doubler plate 28 and showing additional components of said wheel hub assembly comprising a planar circular brim-ring portion 22 having a top-hat portion transverse center bore 23 and a plurality of hub assembly mounting bores 20 radially and selectively distributed through said brim-ring portion; two halves of a cylindrical wheel hub wall 25 that are to be joined to form said cylindrical wheel hub wall and coaxially attached between said brim-ring portion (shown in FIG. 5) and a planar top-side inner ring 15 sized to be coaxially attached to said upper edge of said hub wall and having an inner ring transverse center bore 17 and a plurality of coaxially aligned transverse gearbox mounting bores 29 radially and selectively distributed through said inner ring; said doubler plate 28 having a doubler plate transverse center bore 31, a plurality of doubler plate transverse gearbox mounting bores 33 radially and selectively distributed through said doubler plate coaxially aligned with said mounting bores 29 of said inner ring, and a plurality of transverse hub mounting bores 20 radially and selectively distributed through said doubler plate coaxially aligned with said mounting bores 20 of said brim-ring portion;

FIG. 5 is a perspective view of an assembled top-hat shaped portion 14 of said offset pivot wheel hub assembly showing said brim-ring portion 22 attached to one end of said cylindrical wheel hub wall 25 and said top-side inner ring 15 attached to the other end of said cylindrical hub wall;

FIG. 6 is a partial, perspective view of said irrigation pivot wheel 4 of FIG. 1 showing said top-hat shaped portion 14 mounted to said wheel from the opposite side;

FIG. 7 is an enlarged partial, perspective view of said irrigation pivot wheel 4 of FIG. 6 showing an exemplar retention bolt 16;

FIG. 8 is a partial, perspective view of one half of said irrigation pivot wheel 4 of FIG. 1 showing the hollow nature of said wheel and a plurality of embedded bolt retention anchors 18 and a plurality of transverse through wheel bores 24;

FIG. 9 is a partial, cross-sectional end view of one quarter of said irrigation pivot wheel 4 of FIG. 1 showing the hollow nature of said wheel and showing within the interior of said wheel one of a plurality of radially distributed molded wheel spokes 50 resulting from bridging of molten LLPE resin during the rotational molding process between the selected facing portions of said wheel mold, and showing two of the bulging portions 52 of said interior wheel walls that each embed one of said bolt retention anchors;

FIG. 10 is an enlarged partial, cross-sectional end view of one quarter of said irrigation pivot wheel 4 of FIG. 1 showing two of said bulging portions 52 of said interior wheel walls that each embed one of said bolt retention anchors and three of said retention bolts 16

FIG. 11 is an end view of a canted tread irrigation pivot wheel 5 showing a circumferential canted wheel tread surface 19 and a plurality of canted tread lugs 21 canting transversely from right to left across said canted wheel tread surface in to a selected degree C. selected from a range of 2 to 7 degrees of cant;

FIG. 12 is an end view of a transverse tread irrigation pivot wheel 4 showing a circumferential transverse wheel tread surface 7 and a plurality of transverse tread lugs across said transverse wheel tread surface;

FIG. 13 is a partial, perspective side view of a rotational molding mold 60 having a lower mold portion 62 and an upper mold portion 64 used in the rotational molding of said irrigation pivot wheel 4 of FIG. 1 showing two pluralities of cooperating aligned elongated canted triangular pyramidal shaped protrusions 66, 68 towards the interior of said molding mold, said pyramidal shaped protrusions when said mold is charged with resin powder and closed are positioned in aligned facing positions of corresponding protrusions of said lower mold portion to said upper mold portion to form a plurality of radially spaced and distributed radial wheel spokes 50 (a portion of the interior surfaces of one of said spokes is shown in FIG. 9 and FIG. 10) comprised of molten and then congealed and set molding resin powder at the end of said rotational molding of said pivot wheel, showing a plurality of spaced and distributed tread lug mold recesses 70 in the interior circumferential wall of said lower mold portion, and showing a plurality of bolt retention anchors 18 secured to the interior walls of said mold radially distributed around the transverse rotational axis of said wheel to be embedded in the walls of said molded wheel;

FIG. 14 is a partial, perspective view of a generic irrigation tower lower support beam 201 and a pivot line gearbox 204 mounted to said beam showing a drive disc attached to and linearly offset a distance A from the rest of said gearbox and showing eight mounting studs 208 in an 8×8 array around the rotational axis of said drive disc, said drive disc to receive and mount a selected pivot wheel 4, 5 with said studs mounted first through said gearbox mounting bores 33 of said doubler plate 28 and then second through said gearbox mounting bores 29 of said top-side inner ring 15 and then secured to said wheel by eight mounting nuts (not shown).;

FIG. 15 is a side view of said gearbox 204 and said attached drive disc 200 and said beam 201 shown in FIG. 14 and showing a linear offset distance A (about four inches from the remainder of said gearbox); and

FIG. 16 is a side view of a pivot line gearbox 206 mounted to a support beam showing a drive disc 202 attached to and linearly offset a distance B (about seven inches) from the remainder of said gearbox and showing eight mounting studs 208 in an 8×8 array around the rotational axis of said drive disc, said drive disc to receive and mount a selected pivot wheel 4, 5 with said studs mounted first through said gearbox mounting bores 29 of said top-side inner ring 15 and second through said gearbox mounting bores 33 of said doubler plate 28 and then secured by eight mounting nuts (not shown).

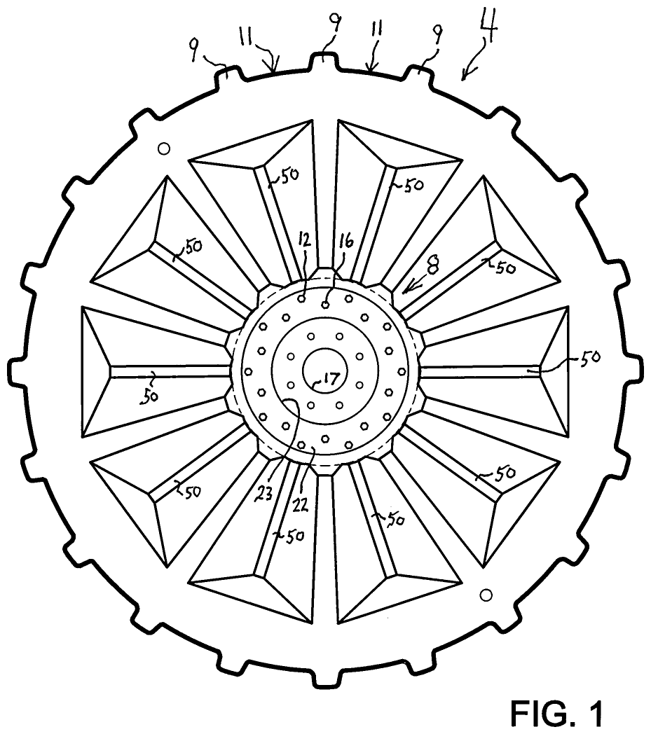

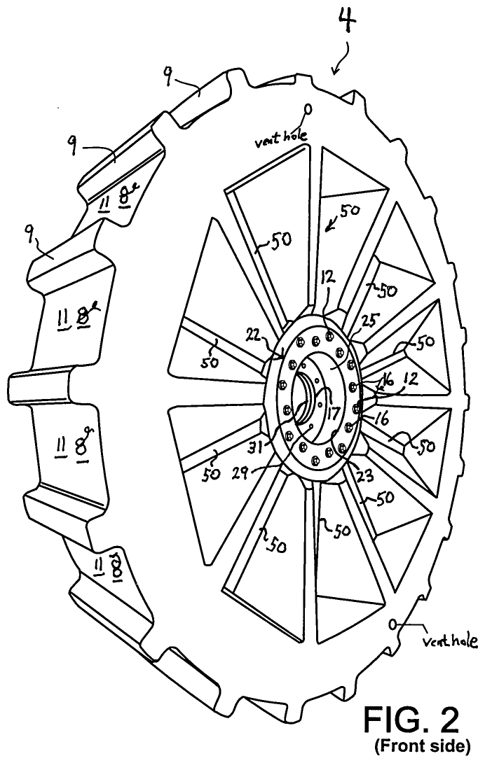

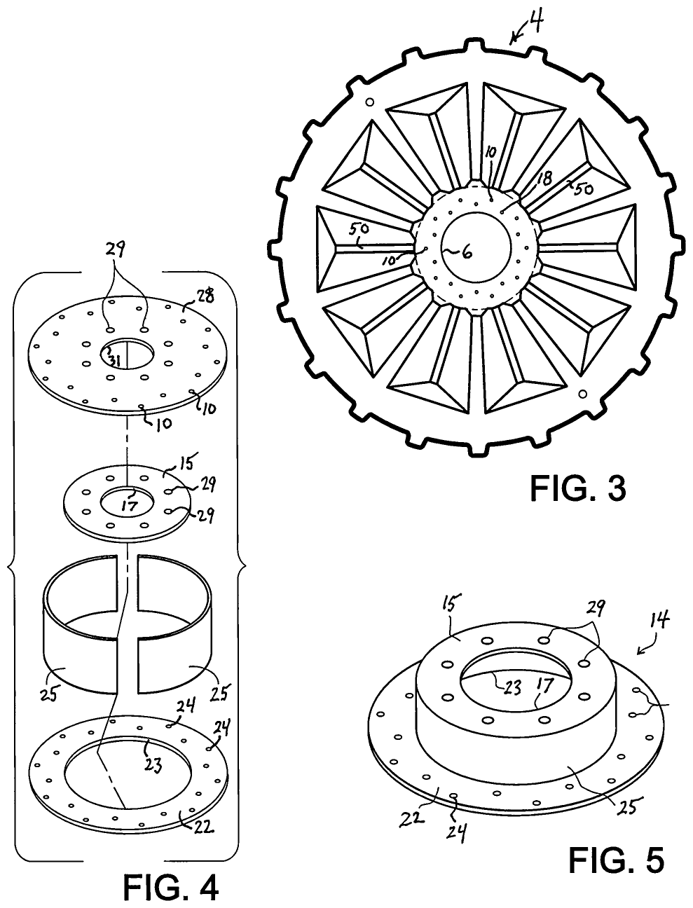

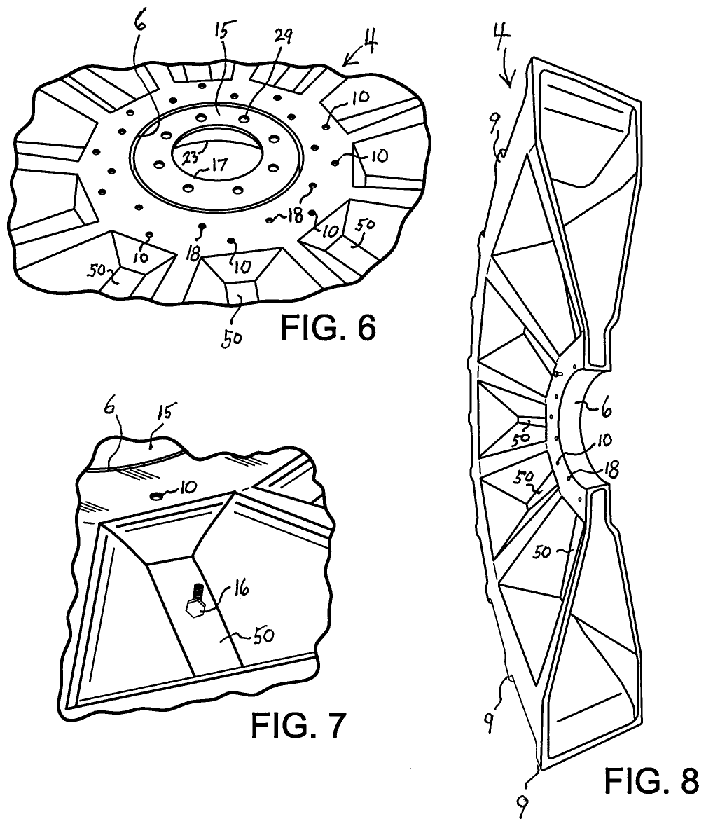

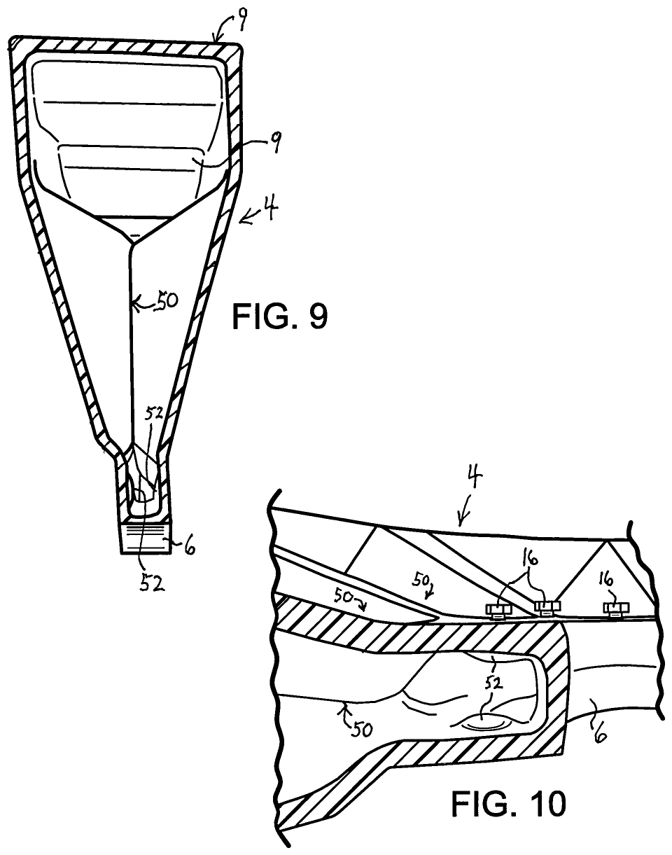

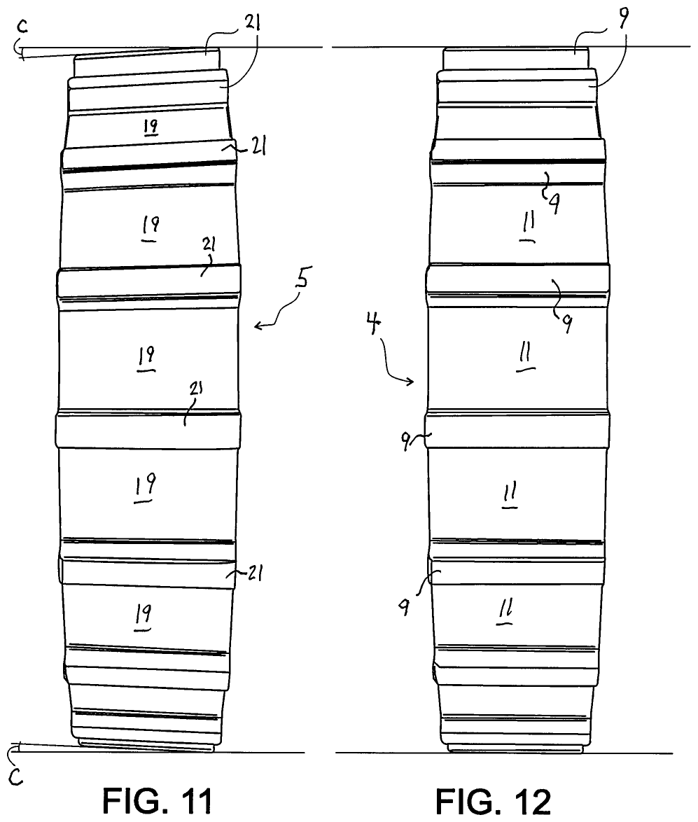

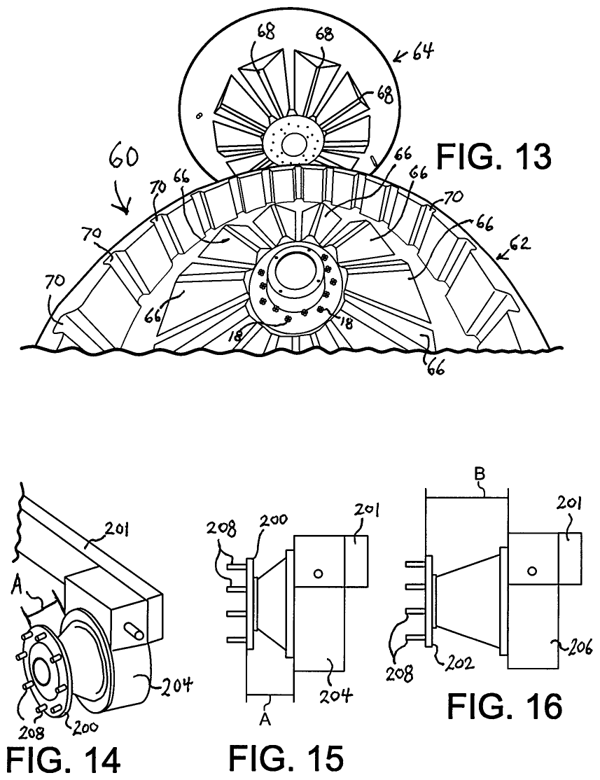

The present invention claims a molded wheel hub that can be rotationally molded with said molded wheel hub laterally positioned offset a selected distance from the lateral centerline of said wheel in a range of offset distance from on centerline towards one side or the other of said wheel of one inch to three inches by modification of the rotational mold.

The preceding description and exposition of the invention is presented for purposes of illustration and enabling disclosure. It is neither intended to be exhaustive nor to limit the invention to the precise forms disclosed. Modifications or variations in the invention in light of the above teachings that are obvious to one of ordinary skill in the art are considered within the scope of the invention.

1. A molded irrigation pivot wheel for use in an agricultural irrigation system comprising: a rotationally molded wheel having an axial central transverse bore for receiving, mounting, and retaining therein a reversible offset wheel hub assembly, said hub assembly attachable to a drive disc of a pivot line gearbox.

2. The molded irrigation pivot wheel of claim 1, wherein said offset wheel hub assembly comprises a top-hat shaped portion having a planar top-side inner ring, said inner ring having a plurality of gearbox mounting bores for receiving, mounting, and retaining a plurality of mounting studs of said drive disc of said pivot line gearbox.
